(19) United States
(12) Patent Application Publication
(10) Pub. No.: US 2010/0201652 A1
(43) Pub. Date: Aug. 12, 2010

(54) EMBEDDED PIEZOELECTRIC ELEMENTS IN TOUCH PANELS

(75) Inventors: Turan CALISKAN, Malmo (SE); Idris OMEROVIC, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/369,837

(22) Filed: Feb. 12, 2009

(51) Int. Cl. G06F 3/041; H04M 1/02

(52) U.S. Cl. 345/177; 379/433.07; 178/18.04

(57) ABSTRACT

A system includes a touch panel, a touch panel controller and a voltage source. The touch sensitive touch panel is formed with one or more piezoelectric elements disposed in an interior of the touch panel. The touch panel controller identifies an occurrence of a touch upon the touch panel and generates one or more control signals based on the occurrence of the touch. The voltage source receives the one or more generated control signals, and applies voltages to at least one of the one or more piezoelectric elements based on the one or more control signals.

### BACKGROUND

Touch panels, touch screens, keypads and keyboards may be used in many electronic devices, such as cellular telephones, computers, personal digital assistants (PDAs), smartphones, portable gaming devices, media player devices, camera devices, etc. Additionally, many handheld electronic devices include some kind of display to provide a user with visual information. These devices may also include an input device, such as a keypad, touch screen, and/or one or more buttons to allow a user to enter some form of input. A growing variety of applications and capabilities for electronic devices, such as handheld electronic devices, continues to drive a need for improved user input techniques.

### SUMMARY

In one exemplary implementation, a touch sensitive electronic device may include one or more piezoelectric elements; and a touch panel, where the one or more piezoelectric elements are formed within an interior of the touch panel.

Additionally, the one or more piezoelectric elements may be formed within the touch panel between touch sensitive wires of the touch panel and an upper surface of the touch panel.

Additionally, the one or more piezoelectric elements may be formed within the touch panel beneath touch sensitive wires of the touch panel.

Additionally, the one or more piezoelectric elements may be formed within the touch panel in a same internal layer as touch sensitive wires of the touch panel.

Additionally, the touch sensitive electronic device may further include a voltage source configured to selectively apply voltages to the one or more piezoelectric elements to induce a vibration in the one or more piezoelectric elements and to further cause the touch panel to vibrate.

Additionally, the one or more piezoelectric elements may include piezoelectric actuators.

Additionally, the touch sensitive electronic device may include a radiotelephone, a Personal Communications System (PCS) terminal, a personal digital assistant (PDA), a gaming device, a media player device or a digital camera.

In a further exemplary implementation, a system may include a touch panel formed with one or more piezoelectric elements disposed in an interior of the touch panel. The system may further include a touch panel controller configured to: identify an occurrence of a touch upon the touch panel; and generate one or more control signals based on the occurrence of the touch. The system may also include a voltage source configured to: receive the one or more generated control signals; and apply voltages to at least one of the one or more piezoelectric elements based on the one or more control signals.

Additionally, the one or more piezoelectric elements may be formed within the touch panel between touch sensitive wires of the touch panel and an upper surface of the touch panel.

Additionally, the one or more piezoelectric elements may be formed within the touch panel beneath touch sensitive wires of the touch panel.

Additionally, the system may include one of a radiotelephone, a Personal Communications System (PCS) terminal, a personal digital assistant (PDA), a gaming device, a media player device or a digital camera.

Additionally, the piezoelectric elements may vibrate based on the applied voltages further causing the touch panel to vibrate.

In another exemplary implementation, a telephone may include a display incorporating a touch panel, where the touch panel has one or more piezoelectric actuators disposed in an interior of the touch panel. The telephone may further include a touch panel controller configured to cause voltages to be applied to at least one of the one or more piezoelectric actuators to further cause at least one of the piezoelectric actuators to vibrate.

Additionally, the touch panel controller may be configured to cause the voltages to be applied to the at least one of the one or more piezoelectric actuators based on an occurrence of a touch upon the touch panel.

Additionally, the touch panel controller may be further configured to cause two independent voltages to be applied to two different ones of the one or more of the piezoelectric actuators to cause the two different ones actuators to vibrate independently of one another.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIGS. 1A-1C are diagrams illustrating an overview of an exemplary implementation described herein;

FIG. 2 is a block diagram illustrating components of an electronic device according to an exemplary implementation;

FIG. 3 is a diagram illustrating an exemplary implementation of the electronic device of FIG. 2 where the electronic device includes a radiotelephone;

FIG. 4 is a functional diagram of components of the electronic device of FIG. 2;

FIG. 5 is a flow diagram illustrating an exemplary process for operating the electronic device of FIG. 2; and

FIG. 6 is a diagram illustrating the application of voltages to the electronic device of FIG. 2.

### DETAILED DESCRIPTION

The following detailed description refers to the accompanying drawings. The same reference numbers in different drawings may identify the same or similar elements. Also, the following detailed description does not limit the invention.

Exemplary implementations described herein embed piezoelectric elements within the interior of touch sensitive touch panels used with electronic devices, such as, for example, radiotelephones, personal digital assistants (PDAs), media player devices, etc. Integration of piezoelectric elements within the interior of a touch panel provides an excellent mechanical connection between the touch panel and the touch panel such that transference of the vibration from the piezoelectric elements to the touch panel may be maximized when the piezoelectric actuators act as piezoelectric actuators. Additionally, embedding piezoelectric elements within the interior of touch sensitive panels enables the implementation of piezoelectric actuators without adding extra area/volume to the touch panel, while at the same time providing enhanced functionality of devices incorporating the touch panels described herein.

### Overview

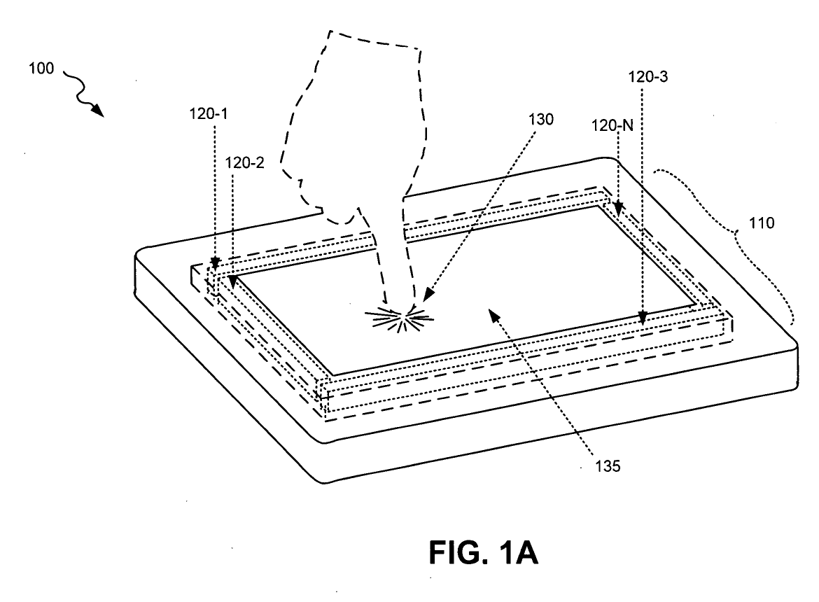

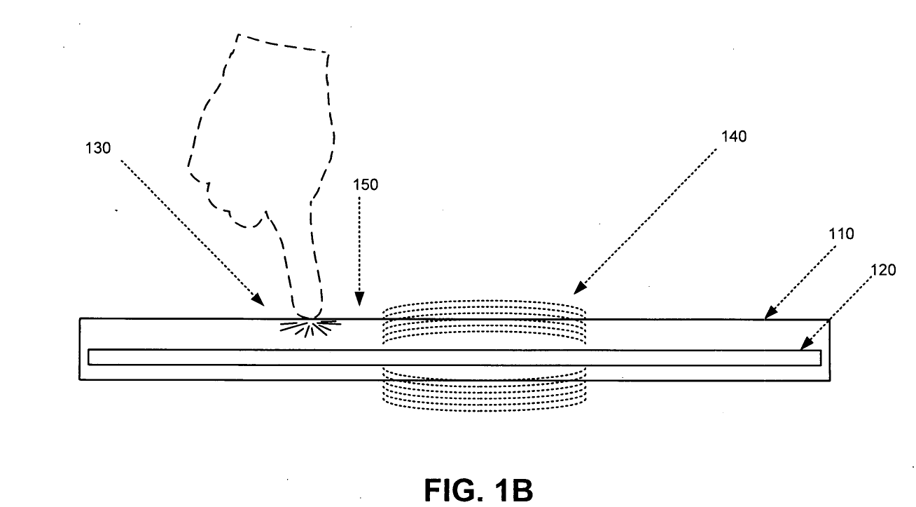

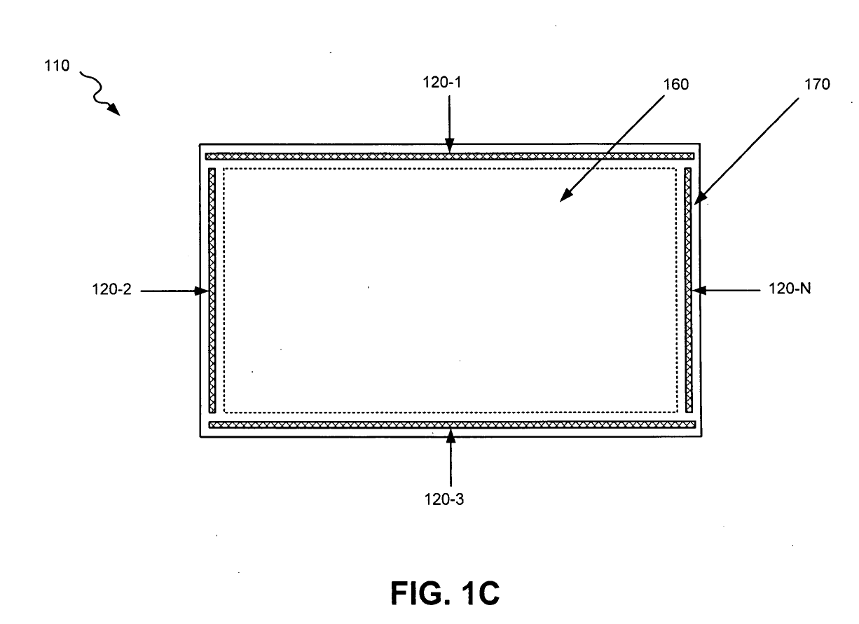

FIG. 1A illustrates an overview of a device 100 having a touch panel 110 with piezoelectric elements 120-1 through 120-N (individually and collectively referred to herein as “piezoelectric element 120”) embedded within an interior of touch panel 110. Touch panel may include a rigid or semi-rigid material, such as, for example glass, plastic, or glass-like materials. Piezoelectric elements 120-1 through 120-N may include any type of known piezoelectric materials (e.g., crystal or ceramic) that may be formed within the interior of touch panel 110. Piezoelectric elements 120-1 through 120-N may be formed at various locations within the interior of touch panel 110. For example, if touch panel 110 includes touch sensitive wires (e.g., wires along X, Y and/or Z axis of touch panel 120), piezoelectric elements 120-1 through 120-N may be formed between the touch sensitive wires and an upper surface of touch panel 110, or beneath the touch sensitive wires. In some implementations, piezoelectric elements 120-1 through 120-N may be formed in parallel with the touch sensitive wires (i.e., on the same internal layer). Piezoelectric elements 120-1 through 120-N, however, may be formed at any location within the interior of touch panel 110.

As shown in FIG. 1A, a user may apply a touch 130 to a region of touch panel to activate one or more functions associated with the operation of device 100. The term “touch,” as used herein, may refer to a touch of an object, such as a body part (e.g., a finger) or a pointing device (e.g., a stylus, pen, etc.).

Touch panel 110 may be integrated with, and/or overlaid on, a display to form a touch screen or a panel-enabled display that may function as a user input interface. For example, in one implementation, touch panel 110 may include a near field-sensitive (e.g., capacitive), acoustically-sensitive (e.g., surface acoustic wave), photo-sensitive (e.g., infra-red), and/or any other type of touch panel overlay that allows a display to be used as an input device. In another implementation, touch panel 110 may include multiple touch-sensitive technologies. Generally, touch panel 110 may include any kind of technology that provides the ability to identify the occurrence of a touch upon touch panel 110.

A display 135 associated with touch panel 110 may include a device that can display signals generated by device 100 as text or images on a screen (e.g., a liquid crystal display (LCD), cathode ray tube (CRT) display, organic light-emitting diode (OLED) display, surface-conduction electro-emitter display (SED), plasma display, field emission display (FED), bistable display, etc.). In certain implementations, display 110 may provide a high-resolution, active-matrix presentation suitable for the wide variety of applications and features associated with typical mobile devices. The display may provide visual information to the user and serve—in conjunction with touch panel 110—as a user interface to detect user input. For example, the display may provide information and menu controls regarding incoming or outgoing telephone calls and/or incoming or outgoing electronic mail (e-mail), instant messages, short message service (SMS) messages, etc. The display may further display information and controls regarding various applications executed by device 100, such as a web browser, a phone book/contact list program, a calendar, an organizer application, image manipulation applications, navigation/mapping applications, an MP3 player, as well as other applications. For example, the display may present information and images associated with application menus that can be selected using multiple types of input commands. The display may also display images associated with a camera, including pictures or videos taken by the camera and/or received by device. The display may also display video games being played by a user, downloaded content (e.g., news, images, or other information), etc.

Device 100 may include any type of electronic device that includes a touch panel (e.g., touch panel 110). For example, device 100 may include a cellular radiotelephone; a smart phone, a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; a gaming device; a media player device; a digital camera; or another device that may use touch panel input. While implementations herein may be described in the context of a handheld electronic device having a touch screen (e.g., a touch panel overlaid on a display), other implementations may include other touch-panel-enabled devices, such as a desktop, laptop or palmtop computer.

As further shown in FIG. 1B, voltages (not shown) applied to piezoelectric element 120 may cause, via a reverse piezoelectric effect, piezoelectric element 120 to vibrate 140, further causing a surface 150 of touch panel 110 to vibrate via the internal mechanical connection between piezoelectric element 120 and touch panel 110. Each of piezoelectric elements 120-1 through 120-N may act as a piezoelectric actuator within touch panel 110. In one exemplary implementation, voltages may be applied to piezoelectric element 120 based on the occurrence of touch 130 on touch panel 110, thus, providing “touch feedback” to the user of device 100 enabling the user to determine, via the vibration of touch panel 110, that the user has successfully made a touch upon touch panel 110.

FIG. 1C depicts an exemplary implementation of touch panel 110 in which one or more piezoelectric elements 120-1 through 120-N may be disposed within touch panel 110 in “inactive” regions of touch panel 110. As shown in FIG. 1C, touch panel 110 may include an active region 160 and an inactive region 170. Active region 160 may include a region or regions of touch panel 110 that accepts touch input. Inactive region 170 may include a region of touch panel 110 that does not accept touch input. For example, inactive region 170 may consist of a region or regions of touch panel 110 located beneath a housing of device 100. Touch panel 110 is shown by way of example in FIG. 1C as having four piezoelectric elements 120 embedded within it. However, any number of piezoelectric elements 120 may be embedded within touch panel 110.

### Exemplary Device

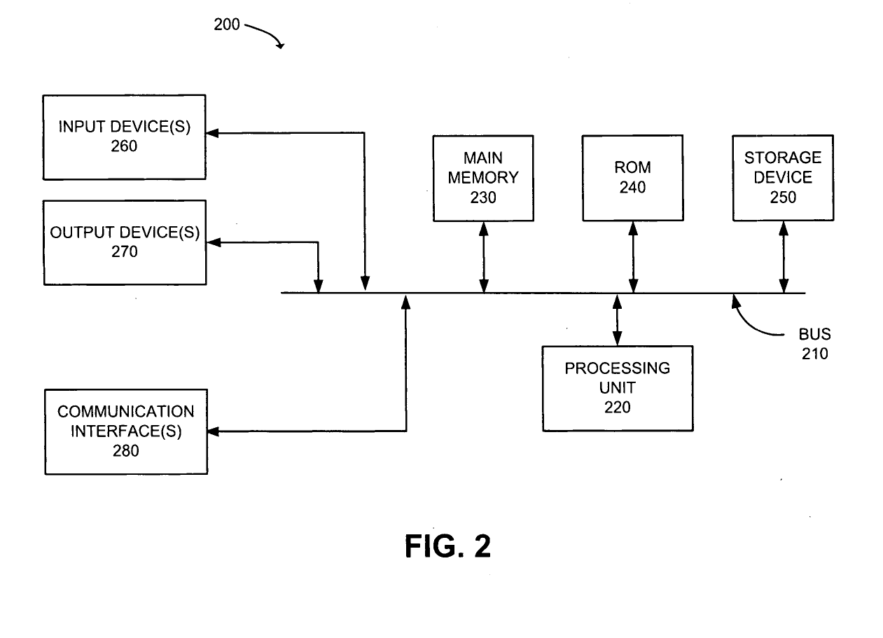

FIG. 2 is a block diagram that depicts exemplary components of device 100. As illustrated, device 100 may include a bus 210, a processing unit 220, a main memory 230, a read only memory (ROM) 240, a storage device 250, an input device(s) 260, an output device(s) 270, and a communication interface(s) 280. Bus 210 may include a path that permits communication among the elements of device 100.

Processing unit 220 may include a conventional processor, microprocessor, or processing logic that may interpret and execute instructions. Main memory 230 may include a random access memory (RAM) or another type of dynamic storage device that may store information and instructions for execution by processor 220. ROM 240 may include a conventional ROM device or another type of static storage device that may store static information and instructions for use by processing unit 220. Storage device 250 may include a magnetic and/or optical recording medium and its corresponding drive.

Input device 260 may include a mechanism that permits an operator to input information to the client/server entity, such as a mouse, a pen, voice recognition and/or biometric mechanisms, etc. Input device 260 may further include touch panel device 110 described above with respect to FIGS. 1A, 1B and 1C. Output device 270 may include a mechanism that outputs information to the operator, including a display, a printer, a speaker, etc. Communication interface 280 may include any transceiver-like mechanism that enables device 100 to communicate with other devices and/or systems.

Device 100 may perform certain operations or processes described herein. Device 100 may perform these operations in response to processing unit 220 executing software instructions contained in a computer-readable medium, such as memory 230. A computer-readable medium may be defined as a physical or logical memory device. Each of main memory 230, ROM 240 and storage device 250 may include computer-readable media. The magnetic and/or optical recording media (e.g., readable CDs or DVDs) of storage device 250 may also include computer-readable media.

The software instructions may be read into memory 230 from another computer-readable medium, such as data storage device 250, or from another device via communication interface 280. The software instructions contained in memory 230 may cause processing unit 220 to perform operations or processes described herein. Alternatively, hardwired circuitry may be used in place of or in combination with software instructions to implement processes described herein. Thus, implementations described herein are not limited to any specific combination of hardware circuitry and software.

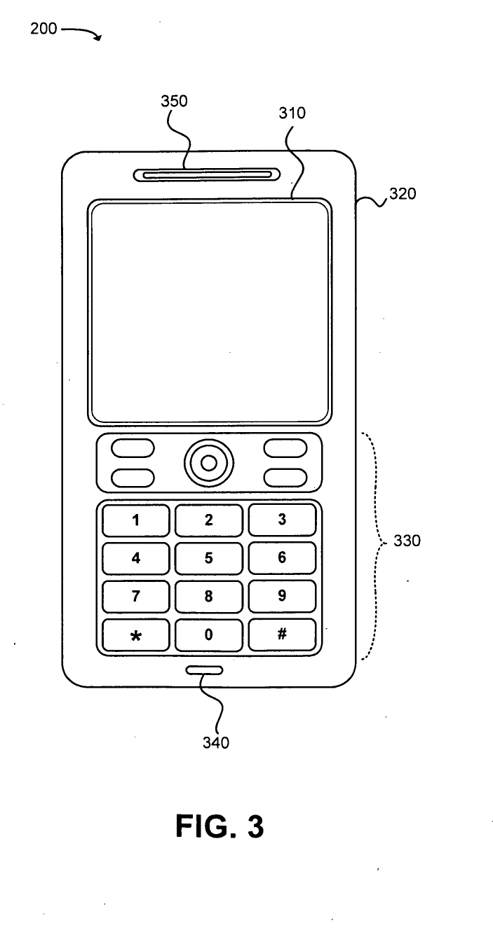

FIG. 3 depicts an exemplary implementation in which device 100 includes a cellular radiotelephone. As shown, the cellular radiotelephone 100 may include a display 310, a housing 320, a keypad 330, a microphone 340, and a speaker 350. Display 310 may incorporate touch panel 110 described above. The components described below with respect to device 100 are not limited to those described herein. Other components, such as a camera, connectivity ports, memory slots, and/or additional speakers, may be located on radiotelephone 100.

Housing 320 may protect the components of device 100 from outside elements. Keypad 330 may provide input to device 100. Keypad 330 may include a standard telephone keypad. Keys on keypad 330 may perform multiple functions depending upon a particular application selected by the user. In one implementation, each key of keypad 330 may be, for example, a pushbutton. A user may utilize keypad 330 for entering information, such as text or a phone number, or activating a special function. Alternatively, keypad 330 may take the form of a keyboard that may facilitate the entry of alphanumeric text.

Microphone 340 may receive audible information from the user. Microphone 340 may include any component capable of transducing air pressure waves to a corresponding electrical signal. Speaker 350 may provide audible information to a user of device. Speaker 350 may include any component capable of transducing an electrical signal to a corresponding sound wave. For example, a user may listen to music through speaker 350.

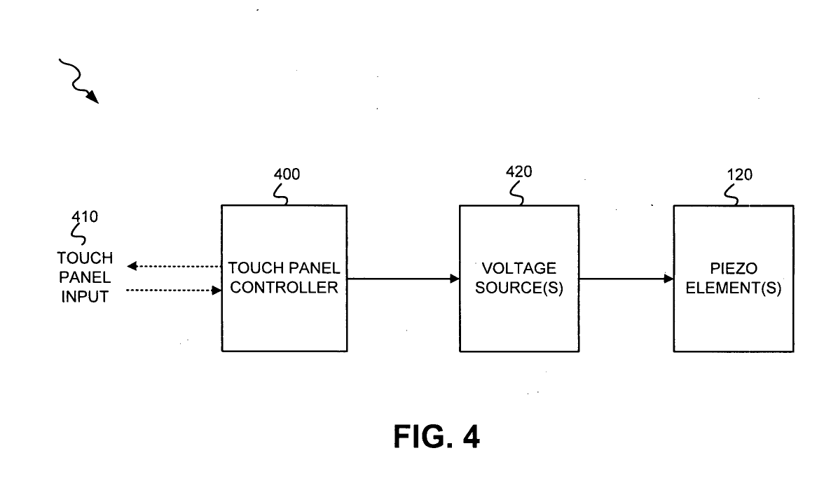

FIG. 4 is a functional diagram of components of device 100 associated with the operation of touch panel 110. The functional components of device 100 may include a touch panel controller 400, a voltage source(s) 420, and piezoelectric elements 120. Touch panel controller 400 may receive touch panel input via touch panel 110 (e.g., signals indicating that a touch has occurred upon touch panel 110). Based on receipt of touch panel inputs 410, touch panel controller 400 may send a control signal(s) to voltage source(s) 420 to apply an appropriate voltage(s) to one or more of piezoelectric elements 120. Application of the voltage(s) to piezoelectric element(s) 120 by voltage source(s) 420 may cause piezoelectric element(s) 120 to vibrate. In one implementation, voltage source(s) 420 may apply a sequence of alternating positive and negative voltages to one or more of piezoelectric elements 120 to cause elements 120 to vibrate. In some implementations, each piezoelectric element 120 embedded within touch panel 110 may be controlled independently of each other piezoelectric element 120.

### Exemplary Process

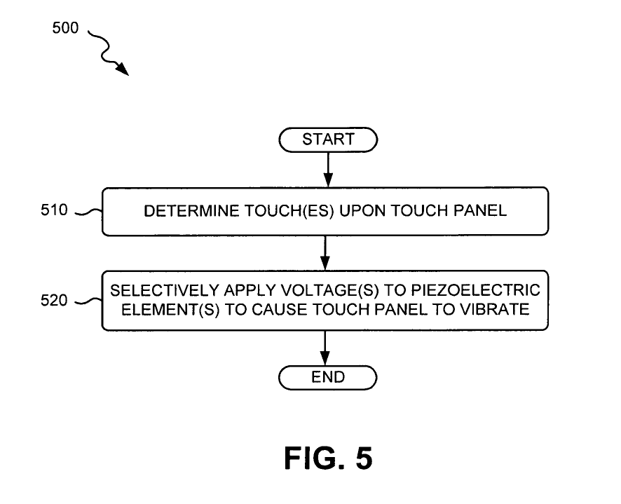

FIG. 5 is a flow diagram illustrating an exemplary process 500 for operating device 100 of FIG. 1. The exemplary process of FIG. 5 may be performed by touch panel controller 400, possibly in conjunction with other components of device 100.

The exemplary process may begin with the determination of whether a touch(es) has occurred upon touch panel 110 (block 510). Touch panel 110, upon the occurrence of a touch(es), may supply a touch panel input 410 to touch panel controller 400. Based on receipt of touch panel input 410, touch panel controller 400 may identify the occurrence of a touch upon touch panel 110.

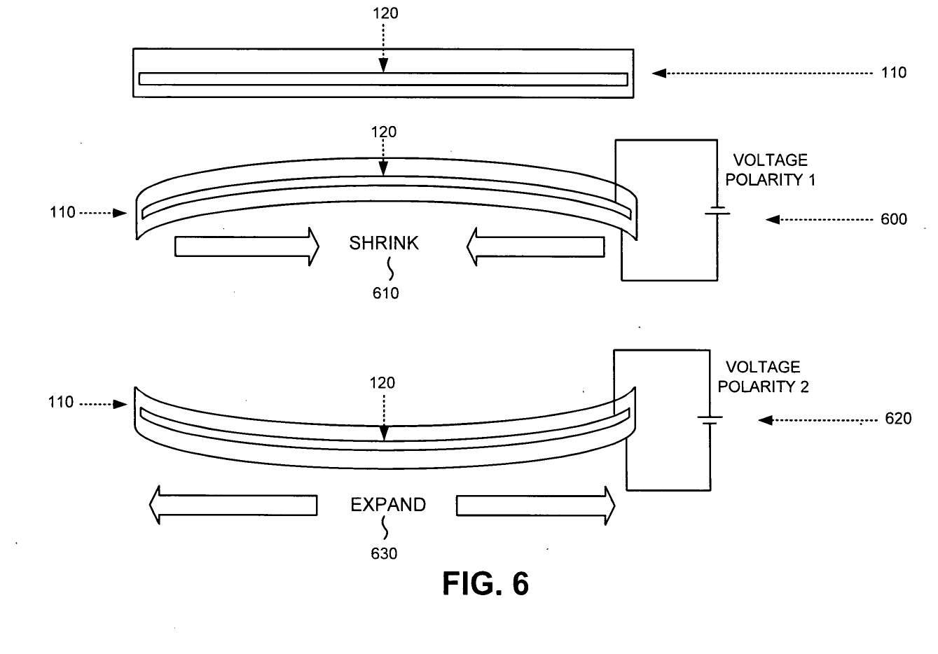

A voltage(s) may be selectively applied to piezoelectric elements 120 to cause touch panel 110 to vibrate (block 520). Touch panel controller 400 may generate a control signal, based on the occurrence of a touch upon touch panel 110, to control voltage source(s) 420 to apply voltages to one or more of piezoelectric elements 120-1 through 120-N. For example, as shown in FIG. 6, a voltage 600 of a first polarity may be applied to piezoelectric element 120 causing piezoelectric element 120 to shrink 610. A voltage 620 of a second polarity may be applied to piezoelectric element 120 causing piezoelectric element 120 to expand 630. By alternating application of voltages 600 and 620, piezoelectric element 120 may be made to vibrate, causing touch panel to, in turn, vibrate. In one exemplary implementation, voltage source 420 may apply a sequence of alternating voltages to piezoelectric element 120 for a specified period of time. In some implementations, voltage source(s) 420 may supply independent, different voltages to each of piezoelectric elements 120-1 through 120-N. Thus, each of piezoelectric elements 120-1 through 120-N may be vibrated independently of one another (or groups of piezoelectric elements may be vibrated independently of other groups.

### CONCLUSION

Implementations described herein may provide touch sensitive touch panels in which piezoelectric actuators may be embedded in the interior of the touch panels. Integration of piezoelectric actuators within the interior of the touch panel can provide an excellent mechanical connection between the touch panel and piezoelectric actuators such that transference of the vibration from the piezoelectric actuators to the touch panel may be maximized.

The foregoing description of the implementations described herein provides illustration and description, but is not intended to be exhaustive or to limit the invention to the precise form disclosed. Modifications and variations are possible in light of the above teachings or may be acquired from practice of the invention. For example, while embodiments have been described herein as using piezoelectric elements 120 for providing “touch feedback,” piezoelectric elements 120 may alternatively be used as audio speakers and/or for making measurements of pressure (e.g., how hard/soft the user presses upon the touch panel) by measuring voltages induced by the piezoelectric elements via the piezoelectric effect.

Further, while a series of blocks has been described with respect to FIG. 5, the order of the blocks may be varied in other implementations. Moreover, non-dependent blocks may be performed in parallel.

Aspects described herein may be implemented in methods and/or computer program products. Accordingly, aspects may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement these aspects is not limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include firmware, hardware—such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A touch sensitive electronic device, comprising:
one or more piezoelectric elements; and
a touch panel, where the one or more piezoelectric elements are formed within an interior of the touch panel.

2. The electronic device of claim 1, where the one or more piezoelectric elements are formed within the touch panel between touch sensitive wires of the touch panel and an upper surface of the touch panel.

3. The electronic device of claim 1, where the one or more piezoelectric elements are formed within the touch panel beneath touch sensitive wires of the touch panel.

4. The electronic device of claim 1, where the one or more piezoelectric elements are formed within the touch panel in a same internal layer as touch sensitive wires of the touch panel.

5. The electronic device of claim 1, further comprising:
a voltage source configured to selectively apply voltages to the one or more piezoelectric elements to induce a vibration in the one or more piezoelectric elements and to further cause the touch panel to vibrate.

6. The electronic device of claim 1, where the one or more piezoelectric elements comprises piezoelectric actuators.

7. The electronic device of claim 1, where the electronic device comprises a radiotelephone, a Personal Communications System (PCS) terminal, a personal digital assistant (PDA), a gaming device, a media player device or a digital camera.

8. A system, comprising:
a touch panel formed with one or more piezoelectric elements disposed in an interior of the touch panel;
a touch panel controller configured to:
identify an occurrence of a touch upon the touch panel;
generate one or more control signals based on the occurrence of the touch;
a voltage source configured to:
receive the one or more generated control signals; and
apply voltages to at least one of the one or more piezoelectric elements based on the one or more control signals.

9. The system of claim 8, where the one or more piezoelectric elements are formed within the touch panel between touch sensitive wires of the touch panel and an upper surface of the touch panel.

10. The system of claim 8, where the one or more piezoelectric elements are formed within the touch panel beneath touch sensitive wires of the touch panel.

11. The system of claim 8, where the system comprises one of a radiotelephone, a Personal Communications System (PCS) terminal, a personal digital assistant (PDA), a gaming device, a media player device or a digital camera.

12. The system of claim 8, where the piezoelectric elements vibrate based on the applied voltages further causing the touch panel to vibrate.

13. A telephone, comprising:
a display incorporating a touch panel, where the touch panel has one or more piezoelectric actuators disposed in an interior of the touch panel; and
a touch panel controller configured to cause voltages to be applied to at least one of the one or more piezoelectric actuators to further cause at least one of the piezoelectric actuators to vibrate.

14. The telephone of claim 13, where the touch panel controller is configured to cause the voltages to be applied to the at least one of the one or more piezoelectric actuators based on an occurrence of a touch upon the touch panel.

15. The telephone of claim 13, where the touch panel controller is further configured to cause two independent voltages to be applied to two different ones of the one or more of the piezoelectric actuators to cause the two different ones actuators to vibrate independently of one another.
